(19) United States
(12) Patent Application Publication
(10) Pub. No.: US 2016/0029219 A1
(43) Pub. Date: Jan. 28, 2016

(54) SHADELESS TOUCH ELECTRONIC DEVICE AND UNLOCKING METHOD THEREOF

(71) Applicants: HannStar Display (Nanjing) Corporation, Nanjing (CN); HANNSTAR DISPLAY CORPORATION, Taipei City (TW)

(72) Inventors: Hsu-Ho WU, Taipei City (TW); Tien-Rong LU, Taipei City (TW)

(21) Appl. No.: 14/793,223

(22) Filed: Jul. 7, 2015

(30) Foreign Application Priority Data
Jul. 25, 2014 (CN) 201410360898.3

(51) Int. Cl. H04W 12/08

(52) U.S. Cl. CPC H04W 12/08

(57) ABSTRACT

An unlocking method is provided for a shadeless touch hand-held electronic device having a panel, a touch-sensing cover and a control unit. The unlocking method comprises: detecting a user's contact of the touch-sensing cover when the hand-held electronic device is in a locked state of user interface; computing a trigger event of the detection points of the touch-sensing cover; comparing the trigger event with the initiative determination condition pre-stored in the hand-held electronic device; and converting the hand-held electronic device into an unlocked state of user interface if the trigger event conforms to the initiative determination condition. The secrecy of the unlocking operation can be enhanced, the user's view can be prevented from being shaded by the finger during the operation, the panel scratch problem can be reduced and the convenience of the single-hand operation can be enhanced.

### CROSS REFERENCE TO RELATED APPLICATIONS

This Non-provisional application claims priority under 35 U.S.C. §119(a) on Patent Application No(s). 201410360898.3 filed in People's Republic of China on Jul. 25, 2014, the entire contents of which are hereby incorporated by reference

### BACKGROUND

1. Technical Field

The invention relates to a hand-held electronic device and an unlocking method thereof, in particular to a shadeless touch hand-held electronic device and an unlocking method thereof.

2. Related Art

With the progress of technologies, various novel information devices configured with communication function are invented, such as cell phones, tablet computers, ultrabooks, wearable devices and GPS (Global Positioning System) navigation devices. Generally, a keyboard and mouse are commonly applied to manipulate digital devices for inputting information. Additionally, the touch control technology currently also becomes a popular manipulation approach for digital devices and brings an intuitive operation. Accordingly, a touch display device adopting the touch control technology can provide a user friendly and intuitive interface for the input operation, and therefore users of all ages can manipulate the touch display device by fingers or a stylus. For the current hand-held electronic device configured with the touch function, the touch operation is almost executed directly on the panel.

In consideration of the information security, the biometric recognition can be applied to the unlocking function of an electronic device, wherein the fingerprint recognition is the most common technology applied thereto. However, either user's operation on device or the biometric recognition is implemented on the panel, the user's fingers may shade the user's view or the functional item displayed on the panel, so that the user may erroneously touch an undesired item which is displayed in a high information density content by the finger. Besides, when the user inputs more secret information on the panel, such as implementing the unlocking operation by codes or another particular method, people who have malicious intention may seize the chance to give a furtive glance and thus the information security is endangered.

Moreover, because the user needs to touch and operate the electronic device on the panel, the problem of panel scratch frequently happens. Furthermore, in the common use of the hand-held electronic device having the touch function, one hand is used to hold the electronic device while the other hand is used to execute the operation on the panel. So, when the user just uses one hand to hold and operate the device simultaneously, the touch operation just can be limitedly executed by the thumb, and this is inconvenient for effective operation. Besides, with the increased panel size of the hand-held electronic device, the multi-finger touch operation by one hand can't be achieved anymore.

Furthermore, the panel also needs to be configured with the rare earth transparent touch-sensing structure such as ITO (indium tin oxide) so as to be utilized both in touch and display functions, but the rare earth metal of indium is unceasingly consumed, the cost of the product is increasingly higher. Besides, the conductivity of the rare earth metal is worse than the normal metal. Therefore, adopting the transparent touch-sensing layer made by the rare earth metal of indium is not a good solution at present. In addition, when the user operates the hand-held electronic device under the strong sunlight, the sunlight readability of the panel is so far an unsolved problem. Since the user can't clearly see the information displayed on the panel, the operation is inconvenient as well.

Therefore, a shadeless touch hand-held electronic device and an unlocking method thereof are provided whereby the secrecy of the unlocking operation can be enhanced, the user's view can be prevented from being shaded by the finger during the operation, the panel scratch problem can be reduced and the convenience of the single-hand operation can be achieved.

### SUMMARY

An aspect of the invention is to provide a shadeless touch hand-held electronic device and an unlocking method thereof whereby the secrecy and privacy of the unlocking operation can be enhanced, the user's view can be prevented from being shaded by the finger during the operation, the panel scratch problem can be reduced and the convenience of the single-hand operation can be achieved.

An unlocking method is provided for a shadeless touch hand-held electronic device having a panel, a touch-sensing cover and a control unit. The unlocking method comprises: detecting a user's contact of the touch-sensing cover when the hand-held electronic device is in a locked state of user interface; computing a trigger event of a plurality of detection points on the touch-sensing cover; comparing the trigger event with an initiative determination condition pre-stored in the hand-held electronic device; and converting the hand-held electronic device into an unlocked state of user interface if the trigger event conforms to the initiative determination condition.

In one embodiment, the trigger event comprises a trigger quantity, a trigger quantity distribution, a trigger morphology, a trigger time, a trigger location or a trigger frequency.

In one embodiment, if the trigger morphology indicates multiple area contacts, it is determined not to conform to the initiative determination condition.

In one embodiment, if the trigger morphology of the trigger event indicates a single area contact and the position of the single area contact is located at the upper portion of the hand-held electronic device, it is determined not to conform to the initiative determination condition.

In one embodiment, the area contact means that the diameter of a single touch region on the touch-sensing cover whereby the user contacts or the longest distance from one touch edge to the other touch edge is longer than 7 mm.

In one embodiment, the unlocking method further comprises: receiving a palmprint by a palmprint recognition unit of the hand-held electronic device; comparing the palmprint with a predefined palmprint pattern pre-stored in the hand-held electronic device; and converting the hand-held electronic device into the unlocked state of user interface if the trigger event conforms to the initiative determination condition and the palmprint corresponds to the predefined palmprint pattern.

In one embodiment, the hand-held electronic device is used by one hand.

A shadeless touch hand-held electronic device comprises a panel, a touch-sensing cover and a control unit. The touch-sensing cover has a cover and a touch-sensing structure, partial or total area of the touch-sensing structure is disposed on the cover, and the touch-sensing structure has a plurality of detection points. The control unit is electrically connected to the panel and the touch-sensing cover, and executes steps comprising: detecting a user's contact of the touch-sensing cover when the hand-held electronic device is in a locked state of user interface; computing a trigger event of the detection points on the touch-sensing cover; comparing the trigger event with an initiative determination condition pre-stored in the hand-held electronic device; and converting the hand-held electronic device into an unlocked state of user interface if the trigger event conforms to the initiative determination condition.

In one embodiment, the trigger event comprises a trigger quantity, a trigger quantity distribution, a trigger morphology (which can refer to trigger appearance), a trigger time, a trigger location (which can refer to trigger position) or a trigger frequency.

In one embodiment, if the trigger morphology indicates multiple area contacts, it is determined not to conform to the initiative determination condition.

In one embodiment, if the trigger morphology of the trigger event indicates a single area contact and the position of the single area contact is located at the upper portion of the hand-held electronic device, it is determined not to conform to the initiative determination condition.

In one embodiment, the area contact means that the diameter of a single touch region on the touch-sensing cover whereby the user contacts or the longest distance from one touch edge to the other touch edge is longer than 7 mm.

In one embodiment, the hand-held electronic device further comprises a palmprint recognition unit electrically connected to the control unit.

In one embodiment, the hand-held electronic device is used by one hand.

In one embodiment, the hand-held electronic device further comprises a circuit board, a battery or a memory card between the touch-sensing cover and the panel.

In one embodiment, a wiring connecting to the touch-sensing structure is gathered to a single side for wiring outlet.

In one embodiment, the width of the touch-sensing structure is less than the width of the cover by 5% to 10%.

In one embodiment, the area of the touch-sensing structure and the area of the panel have a ratio relationship, and the control unit converts an input position of the touch-sensing structure into a display position on the panel.

In one embodiment, the touch-sensing structure comprises metal mesh, metal nanowires, transparent conducting film, carbon nanotube or graphene.

In one embodiment, the touch-sensing cover further comprises a near field communication unit having a near field communication chip and an antenna, the near field communication chip is electrically connected to the control unit, and the antenna is disposed on the cover or the touch-sensing structure.

As mentioned above, the user can execute the touch operation on the touch-sensing cover of the shadeless touch hand-held electronic device and unlocking method thereof according to this invention, Hence, the user's fingers won't only shade the user's view or the software object displayed on the panel, but also the touch for opening the link in the high information density content won't be erroneously executed. Additionally, since the user operates the electronic device via the touch-sensing cover, the panel scratch problem can be reduced. Moreover, because the user can execute touch operation on the touch-sensing cover, the user can easily execute the unlocking operation through biometric recognition unit meanwhile the panel won't be shaded with holding the hand-held electronic device just by one hand. In comparison with the conventional art where the user just can limitedly use the thumb to execute the operation while using the same hand holding the device, this invention can provide more efficiency and convenience for the manual operation and a wonderful user experience can be achieved.

Besides, the trigger quantity, the trigger quantity distribution, the trigger morphology (which can refer to trigger appearance), the trigger time, the trigger frequency or the trigger location (which can refer to trigger location) must firstly conform to the initiative determination condition, then the hand-held electronic device permits the touch-sensing cover to receive at least one input operation by the user and correspondingly perform an operation such as scrolling the screen in one dimension on the panel. Therefore, when other user uses the hand-held electronic device, because the trigger quantity, the trigger quantity distribution, the trigger morphology, the trigger time, the trigger frequency or the trigger location is distinct from the initiative determination condition which is predefined by the origin user, the hand-held electronic device is forbidden to operate so as to enhance the security and secrecy of the hand-held electronic device.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1 is a schematic diagram showing a shadeless touch hand-held electronic device according to an embodiment of the invention;

FIG. 2 is a function block diagram of the hand-held electronic device shown in FIG. 1;

FIG. 3 is a schematic diagram showing the hand-held electronic device of FIG. 1 in another viewing angle;

FIG. 4 is a schematic flowchart showing the unlocking method of the shadeless touch hand-held electronic device according to an embodiment of the invention;

FIG. 5 is a schematic diagram showing the hand-held electronic device of FIG. 1 is in the locked state of user interface;

FIG. 6 is a schematic diagram showing one operation state of the hand-held electronic device of FIG. 1;

FIGS. 7A to 7B are another schematic diagrams showing the detection point of the touch-sensing cover of FIG. 1 is triggered; and

FIG. 8 is a schematic diagram showing another operation state of the hand-held electronic device of FIG. 1.

### DETAILED DESCRIPTION OF THE INVENTION

The embodiments of the invention will be apparent from the following detailed description, which proceeds with reference to the accompanying drawings, wherein the same references relate to the same elements.

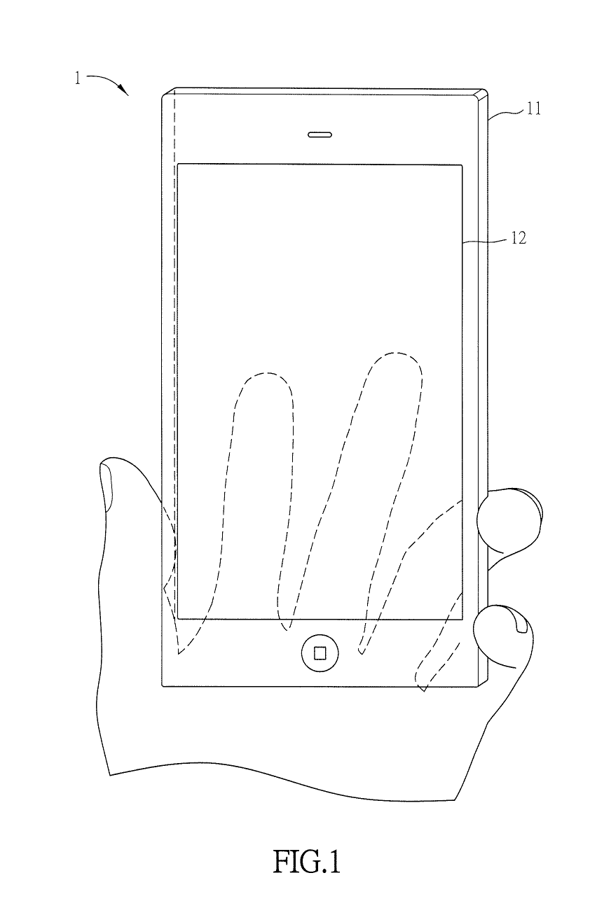

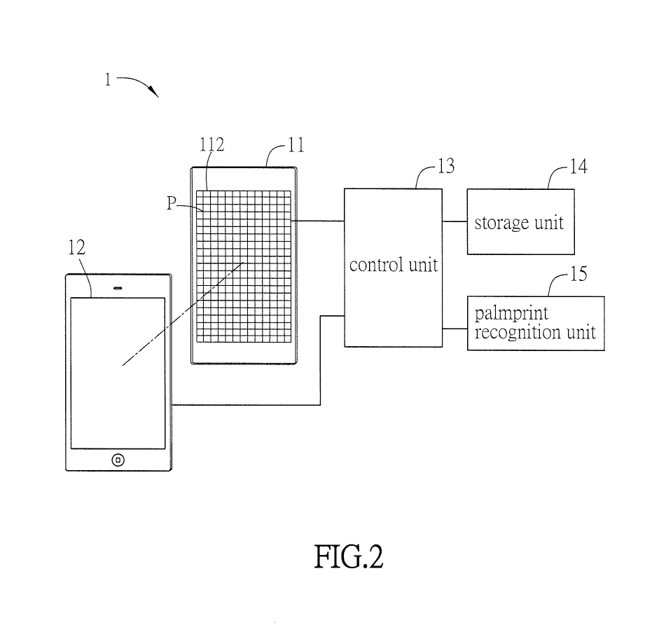

FIG. 1 is a schematic diagram of a shadeless touch hand-held electronic device of an embodiment of the invention, and FIG. 2 is a function block diagram of the hand-held electronic device shown in FIG. 1. As shown in FIGS. 1 and 2, the shadeless touch hand-held electronic device 1 (hereinafter abbreviated as hand-held electronic device 1) of this embodiment comprises a touch-sensing cover 11, a panel 12 and a control unit 13. The panel 12 can comprise a display panel, i.e. a panel with the display function, or a touch display panel having dual functions of display and touch. The hand-held electronic device 1 of this embodiment can comprise a smart phone, a tablet, a personal digital assistant (PDA) or a global positioning system (GPS) device, and this embodiment gives the illustration by taking the smart phone as an example.

In this embodiment, the touch-sensing cover 11 is disposed on the side of the hand-held electronic device 1 against the panel 12. In other words, the touch-sensing cover 11 and the panel 12 are respectively disposed on the opposite sides of the hand-held electronic device 1, i.e. the rear side and the front side of the hand-held electronic device 1. In this embodiment for example, the panel 12 is disposed on the front side of the hand-held electronic device 1, and the touch-sensing cover 11 is disposed on the rear side of the hand-held electronic device 1. In practical, a circuit board, a battery or a memory card can be disposed between the touch-sensing cover 11 and the panel 12 to act as the component parts in the hand-held electronic device 1. However, this invention is not limited thereto, and the component can be added or removed according to the practical requirement or actual design. The touch-sensing cover 11 and the panel 12 are coupled with the control unit 13 so that the control unit 13 can control the content displayed on the panel 12 and control a specific region of the touch-sensing cover 11 whereby user's input actions.

In physical, the touch-sensing cover 11 of this embodiment provides a human-machine interface for inputting and interaction. For example, the panel 12 can display a user interface, such as a graphical user interface (GUI). Therefore, as shown in FIG. 1, the user can see the content displayed by the panel 12 through the front side of the hand-held electronic device 1 and execute the input operation through the touch-sensing cover 11 on the rear side. When the user makes use of the hand-held electronic device 1 under the sunlight or a light source, the user can operate the hand-held electronic device 1 by one hand and also adopt the touch-sensing cover 11 to face the light source for blocking the sunlight or the light source. Because the panel 12 is against the light source, the touch-sensing cover 11 can block the sunlight or the light source and the sunlight readability of the panel 12 can be thus enhanced. Besides, the user can just use one hand to execute the operation or input for the content displayed on the panel by the touch-sensing cover, so as to enhance the operation security of the hand-held electronic device and improve the convenience of the single-hand multi-touch operation under the sunlight.

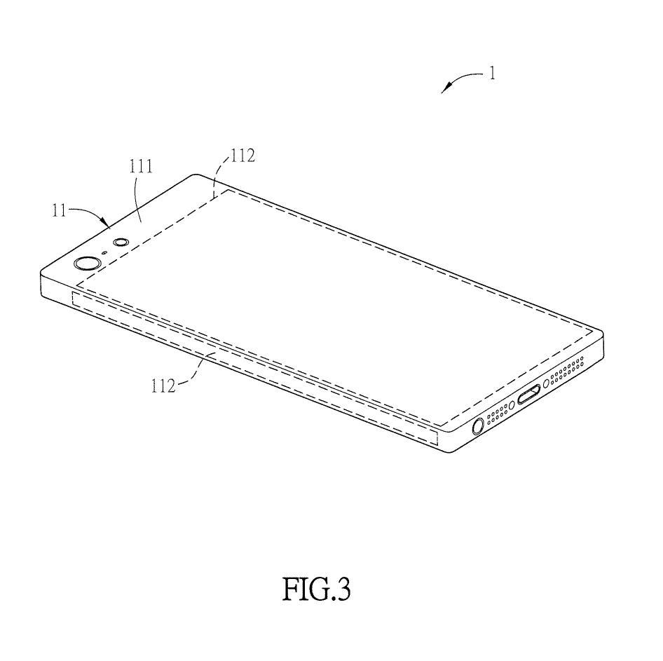

FIG. 3 is a schematic diagram of the hand-held electronic device of FIG. 1 in another viewing angle. As shown in FIGS. 2 and 3, in this embodiment, the touch-sensing cover 11 comprises a cover 111 and a touch-sensing structure 112. Likewise, the cover 111 is disposed on the side of the hand-held electronic device 1 opposite the panel 12 (the opposite side of the display surface). Partial or total area of the touch-sensing structure 112 can be disposed on the cover 111. For example, the touch-sensing structure 112 may also yield to the position of the camera lens or flash of the cover 111, so the touch-sensing structure 112 is not disposed at a local region of the cover 111 (namely the location where the camera lens or the flash are disposed). The local region refers to the inside of the cover 111 or the edge of the cover 111.

In this embodiment, the touch-sensing structure 112 is extended to the two sides of the cover 111 and to the two sides of the touch-sensing cover 11 in order to increase the operation area for the user. For more effectively using the width of the cover 111 to dispose the touch-sensing structure 112, the width of the touch-sensing structure 112 can be slightly less than that of the cover 111 (such as by 5%˜10%). That is, the width of the touch-sensing structure 112 is about 90%˜95% that of the cover 111. In other embodiments, the physical key can be replaced by the touch-sensing structure 112 of this embodiment.

The wiring connecting to the touch-sensing structure 112 can be gathered to a single side for the wiring outlet and then electrically connected with a circuit board, so as to enhance the flexibility and elasticity of the circuit design.

In other embodiments, the area of the touch-sensing structure of the touch-sensing cover can be less than that of the panel. In other words, the area of the touch-sensing structure and the area of the panel have a ratio relationship. The control unit will convert an input position into a display position on the panel according to the ratio relationship.

The touch-sensing structure 112 can be disposed on the inner surface of the cover 111 (the inside of the hand-held electronic device 1) facing the panel 12, or on the outer surface of the cover 111 opposite the panel 12 (the outside of the hand-held electronic device 1), or on the inner surface of the cover 111 facing the panel 12 and the outer surface of the cover 111 opposite the panel 12 (the inside and the outside of the hand-held electronic device 1). The touch-sensing structure 112 of this embodiment can be a capacitive touch-sensing structure for example and formed on the inner surface of the cover 111 facing the panel 12, and is directly formed on the cover 111 with the total area for example. In different embodiments, if the touch-sensing structure 12 is disposed on the outer surface of the cover 111 which is farther from the panel 12, a protection layer is required for protecting the touch-sensing structure 112. The material of the cover 111 can comprise glass, plastic material, metal or other materials, and the cover 111 is a part of the whole structure of the hand-held electronic device 1. In other words, the touch-sensing cover 11 is not an additional component (the additional component is the protection cover of the electronic device for example), so if the touch-sensing cover 11 is separated from the hand-held electronic device 1, the inside components of the hand-held electronic device 1, such as battery or integrated circuit, can be seen. The touch-sensing structure 112 can further include a driving circuit and a sensing circuit (i.e. the so-called Tx and Rx, not shown), and the material thereof can comprise conducting layer (such as a transparent conducting layer, comprising indium tin oxide (ITO), indium zinc oxide (IZO), fluorine-doped tin oxide (FTO), Al-doped ZnO, Ga-doped ZnO for example), metal nanowires, graphene, metal mesh or carbon nanotube, but this invention is not limited thereto.

If the touch-sensing structure 112 is made by metal mesh, the metal texture effect can be exhibited on the appearance when the touch-sensing structure 112 is disposed on the outer surface (not the display surface) of the cover 111. Accordingly, because the metal texture effect can be achieved just by disposing the touch-sensing structure 112 composed of the metal mesh on the outer surface (not the display surface) of the cover 111 made by non-metal material, the metal-made cover (requiring a more complicated process) is not necessary to be adopted and cost can be saved.

As shown in FIG. 2, the touch-sensing structure 112 comprises a plurality of detection points P, which can be triggered to sense a trigger event. For example, when a user touches (such as adopting a stylus, finger or palm) the touch-sensing structure 112, the detection point P at the touch position can be triggered to generate the signal of the trigger event, and the signal will be transmitted to the control unit 13 for the judgment or analysis of the trigger event. Accordingly, the trigger event can be generated by corresponding to the holding position of the user when the user holds the touch-sensing cover 11, or can be generated when the user executes the input operation through the touch-sensing cover 11.

A user's execution of input operation on the touch-sensing cover 11 indicates that the user can operate the hand-held electronic device 1 on the touch-sensing cover 11, as shown in FIG. 1. Besides, the panel 12 can display the corresponding operation according to the user's operation gesture or posture (or called the hand gesture or posture), and the user can operate the user interface displayed on the panel 12. For example, when the user's finger slides on the touch-sensing cover 11, the panel 12 will display a corresponding image (such as an arrow or hand shape) which slides correspondingly.

Accordingly, the touch-sensing cover 11 and the panel 12 are respectively disposed on the opposite sides of the hand-held electronic device 1, so as to prevent the image of the panel 12 from being shaded by the user's finger while the user operates the hand-held electronic device 1 and also avoid the erroneous touch situation.

As shown in FIG. 2, the hand-held electronic device 1 of this embodiment further comprises a storage unit 14, which is, for example but not limited to, ROM (read-only memory), RAM (random access memory), flash, field-programmable gate array (FPGA) or other kinds of memories. Herein for example, the storage unit 14 is illustrated as the RAM and coupled with the control unit 13 by a signal bus.

In this embodiment, the storage unit 14 stores the operation system, application programs, data processing programs and electronic data of various formats. The operation system is the program managing the computer hardware, firmware, and software resources. The application program can be word processing program, email program or others. The data processing program can be used to detect the data structure of the above-mentioned electronic data and generate the corresponding connection instruction. In this embodiment, the control unit 13 comprises a central processing unit (CPU) for example to execute the programs.

In some embodiments, the hand-held electronic device can further comprise a near field communication unit, which comprises a near field communication chip and an antenna. The near field communication chip is electrically connected with the control unit, and the antenna can be disposed on the cover or the touch-sensing structure for example, but this invention is not limited thereto. If the user would like to adopt the hand-held electronic device to communicate with another electronic device through the near field communication (NFC), the hand-held electronic device 1 can be made closer to another electronic device having the near field communication function to receive data from or transmit data to the other electronic device through the antenna and the near field communication chip.

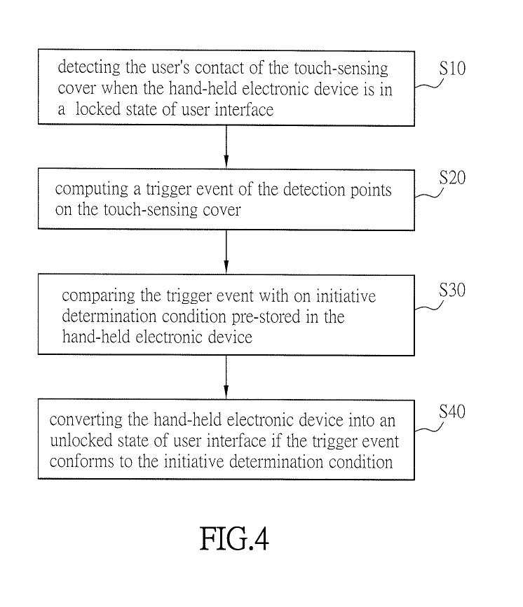

FIG. 4 is a schematic flowchart of the unlocking method showing the shadeless touch hand-held electronic device according to an embodiment of the invention. As shown in FIG. 4, the unlocking method of the shadeless touch hand-held electronic device of this embodiment (abbreviated as the unlocking method) is utilized to determine the input action corresponding to the user's hand gesture to unlock the hand-held electronic device 1. The unlocking method comprises the following steps of: detecting the user's contact of the touch-sensing cover when the hand-held electronic device is in a locked state of user interface (step S10); computing a trigger event of the detection points on the touch-sensing cover (step S20); comparing the trigger event with an initiative determination condition pre-stored in the hand-held electronic device (step S30); and converting the hand-held electronic device into an unlocked state of user interface if the trigger event conforms to the initiative determination condition (step S40).

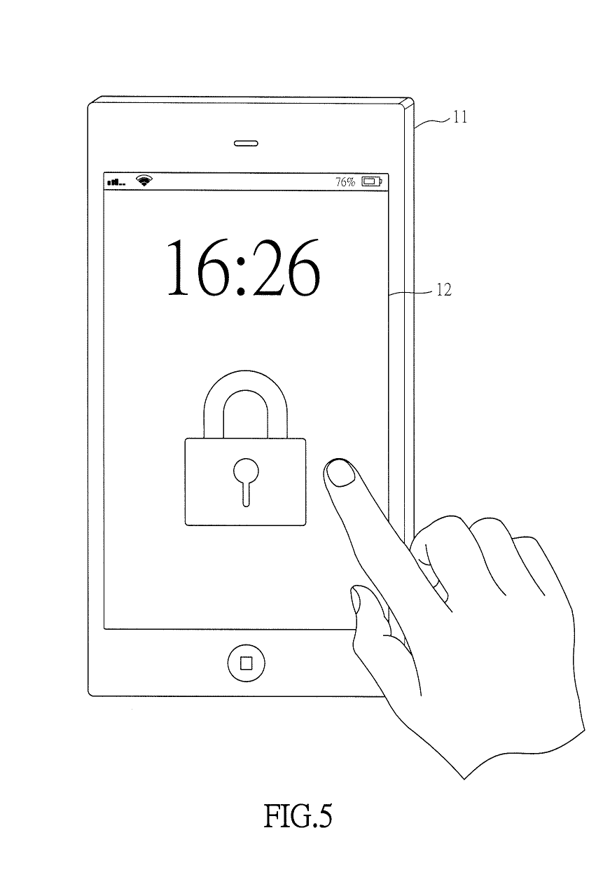

As shown in FIGS. 1, 2, 4 and 5, FIG. 5 is a schematic diagram showing the hand-held electronic device of FIG. 1 is in the locked state of user interface. Physically, in the step S10, when the hand-held electronic device 1 is in the locked state of user interface (as shown in FIG. 5), the contact between the user and the touch-sensing cover is detected. Herein, the so-called locked state of user interface (called the locked state hereinafter) refers to that the hand-held electronic device 1 still can be charged and operated but most of the user's inputs are disabled. In other words, the hand-held electronic device 1 will not execute any action in response to the user's input. In the locked state, the hand-held electronic device 1 still can respond to some kind of the contact on the touch-sensing cover 11. The so-called some kind of the contact comprises the contact that is defined by the hand-held electronic device 1 as the contact that is related to make the hand-held electronic device 1 switched into the unlocked state of user interface, for example, when the user touches the panel 12 by a finger, presses the physical key of the hand-held electronic device 1 or shakes the hand-held electronic device 1. However, this invention is not limited thereto.

When the control unit 13 detects the contact in the step S10, the step S20 will be executed. As shown in FIGS. 1, 2, 4 and 6, in step S20, the control unit 13 computes a trigger event of the detection points P on the touch-sensing cover 11. In details, a part of detection points P of the touch-sensing cover 11 are triggered. The user contacts the touch-sensing cover 11. The detection points P contacted by the user are triggered to correspondingly generate a trigger signal. The control unit 13 is coupled to the touch-sensing cover 11 to receive the trigger signal, and computes the trigger event such as a trigger quantity, a trigger quantity distribution, a trigger morphology (which can refer to trigger appearance), a trigger time, a trigger location (which can refer to trigger position) or a trigger frequency of the triggered detection point P.

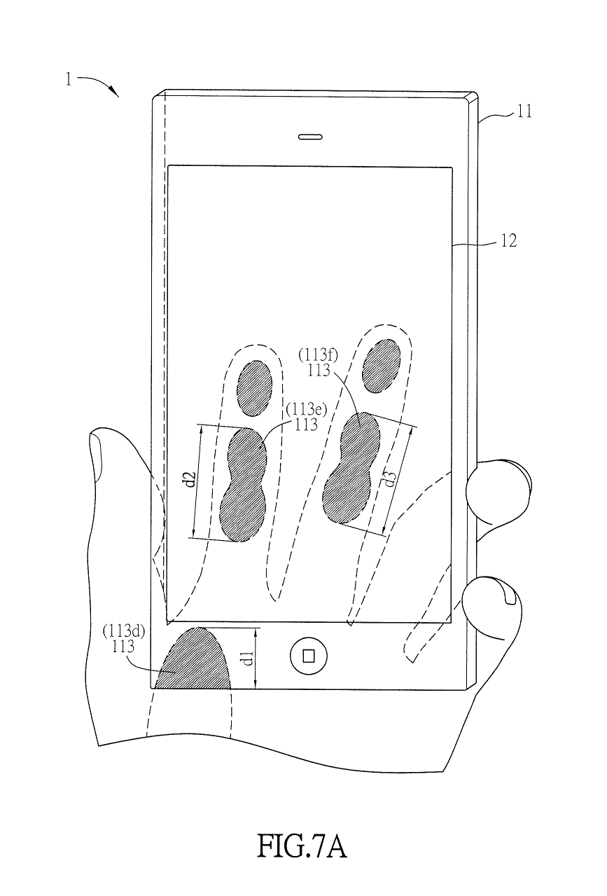

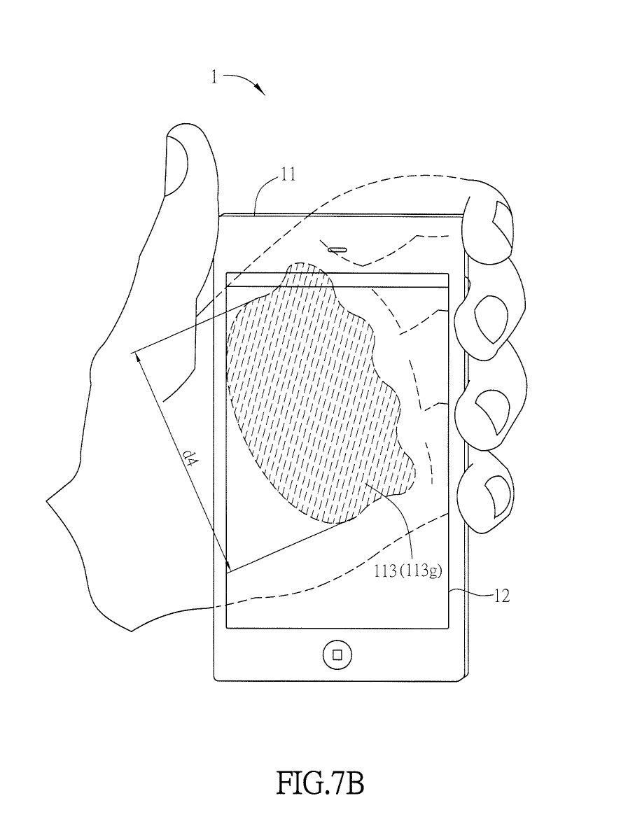

In details, when the user operates the hand-held electronic device 1, the user can preset the holding gesture or posture when operating the setting interface, accordingly, the control unit 13 can analyze the trigger event of the detection point triggered by the user when operating the setting interface. The trigger event can be defined as the initiative determination condition and stored in the storage unit 14. The trigger event comprises the trigger quantity, trigger quantity distribution, trigger time, trigger frequency, trigger morphology (which can refer to trigger appearance) or trigger location (which can refer to trigger position). As to the trigger event of the trigger quantity distribution, trigger morphology or trigger location for example, when the user holds the hand-held electronic device 1, the control unit 13 can analyze the detection point which is triggered by the user's holding and define the region where the number of the adjacent triggered detection points P is larger than a predetermined range as a trigger area 113. As shown in FIG. 7A, in this embodiment, one of the sidewalls of the touch-sensing cover 11 has a trigger area 113a, the other sidewall has two trigger areas 113b, and the surface of the touch-sensing cover 11 opposite the panel 12 has a trigger area 113c. Furthermore, in this embodiment, the trigger quantity distribution and the trigger location respectively indicate the quantity and the location of each trigger area, and the trigger morphology indicates the shape or appearance of each trigger area 113, i.e. the shapes or appearance of the trigger areas 113a, 113b and 113c. Moreover, the trigger frequency can indicate the click frequency at a certain location or specific position, and the trigger time indicates that the holding time exceeds a certain time or related to the user's personal habit.

Accordingly, after the user completing the setting via the setting interface and the storage unit 14 stores the initiative determination condition, the control unit 13 can compare other trigger events with the initiative determination condition. If other trigger events occur, the control unit 13 will compute the trigger quantity, trigger quantity distribution, trigger time, trigger frequency, trigger morphology or trigger location of the detection point on the touch-sensing cover 11 triggered by other trigger events, and also compare the computed result with the initiative determination condition pre-stored in the hand-held electronic device 1. In other embodiments, in order to enhance the security and secrecy of the hand-held electronic device 1, the control unit 13 will compute the trigger event on the touch-sensing cover 11 at a predetermined time intervals. In other words, the control unit 13 will compute the trigger quantity, trigger quantity distribution, trigger time, trigger frequency, trigger morphology or trigger location of the detection point triggered at different times.

In this embodiment, when the setting is completed and a conductor (such as the user's finger) touches the touch-sensing cover 11, accordingly, the control unit 13 can compute the trigger event of the triggered detection point P (step S20) and compare the computed trigger event with the initiative determination condition pre-stored in the hand-held electronic device (step S30). As mentioned above, the initiative determination condition in the embodiment can be the position of the hand-held electronic device 1 wherein the user holds when using the hand-held electronic device 1.

Therefore, the hand-held electronic device 1 is converted into an unlocked state of user interface (hereinafter unlocked state) if the trigger event conforms to the initiative determination condition. In other words, the trigger quantity, the trigger quantity distribution, the trigger morphology, the trigger time, the trigger location or the trigger frequency must satisfy the initiative determination condition first, and then the control unit 13 will convert the hand-held electronic device 1 into the unlocked state. Therefore, when another user holds the hand-held electronic device 1 and would like to operate it, the one will fail to unlock the hand-held electronic device 1 because the trigger event is distinct from the initiative determination condition which the original user has predefined so as to enhance the security of the hand-held electronic device 1. The controller 13 can compute the trigger event of the detection points P with a determined time interval and compare it with the initiative determination condition. Thus, the security of the hand-held electronic device 1 is enhanced.

When the hand-held electronic device 1 in converted into the unlocked state, the hand-held electronic device 1 can display the user interface objects (e.g. icon) corresponding to one or more functions on the panel 12 and/or the information that the user may be interested in. These user interface objects which constitute the user interface of the hand-held electronic device 1, for example but not limited to, which comprise a text, an image, an icon, a virtual key, a pull-down menu, an option button, a confirm box, an optional list or a dialog box. The displayed user interface objects can comprise a non-interactive object for transmitting information or constituting the user interface appearance, or an interactive object for user operation, or a combination of those.

In addition, in some embodiments, the hand-held electronic device 1 is converted from the locked state into the unlocked state, the hand-held electronic device 1 can provide the visible sign, for example it displays the information box on the panel 12 showing the converting procedure is not success to notice the user who does not successfully input a trigger event which conforms to the initiative determination condition. However, it is not limited thereto. In addition to the visible feedback, the hand-held electronic device 1 can further provide an invisible sign for indicating the rate of progress for example comprising audio notices (e.g. voice) or physical notices (e.g. vibration).

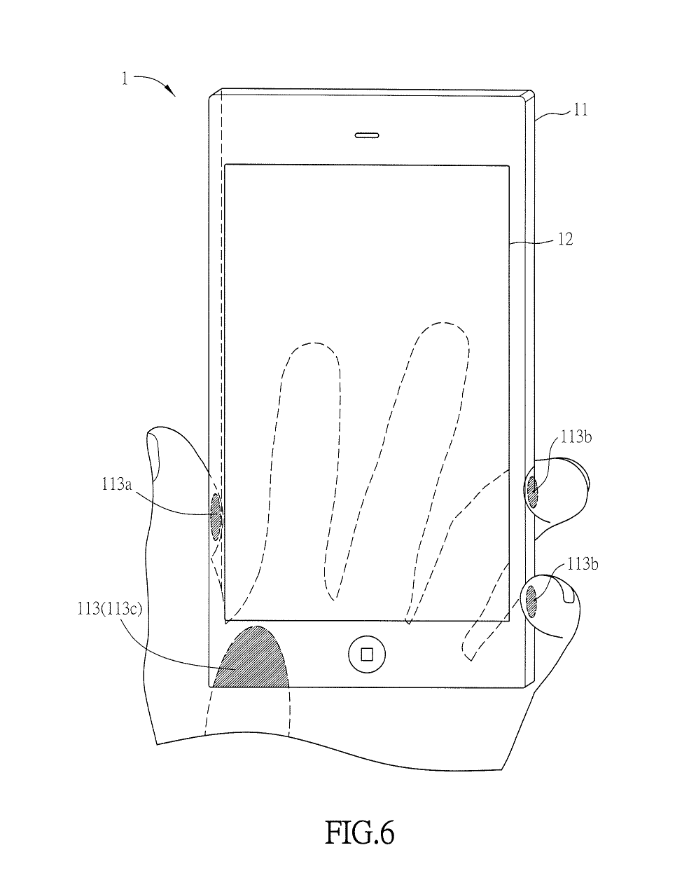

The pattern of the above trigger event is not limited. FIGS. 7A to 7B are another schematic diagrams showing the detection point of the touch-sensing cover of FIG. 1 is triggered. Referring to FIG. 7A, if the trigger morphology indicates multiple area contacts, it is determined not to conform to the initiative determination condition. Here, multiple means two or more than two. In the embodiment, “area contact” means that the diameter of a single touch region on the touch-sensing cover 11 whereby the user contacts or the longest distance from one touch edge to the other touch edge is longer than 7 mm. Taking FIG. 6 for example, because the trigger zones 133d, 133e, 113f are not circles, therefore when longest distances d1, d2, d3 from one touch edge to the other touch edge of the trigger zones 133d, 133e, 113f or more trigger zones are longer than 7 mm, it is directly determined that the trigger event does not conform to the initiative determination condition. The above configuration is based on the condition that it is easy to generate the trigger morphology as multiple area contacts when the user does not perform touch operation on the hand-held electronic device 1 and only simply holds the hand-held electronic device 1. Thus, such the trigger event is determined not to conform to the initiative determination condition.

Referring to FIG. 7B, if the trigger morphology of the trigger event indicates a single area contact and the position of the single area the contact is located at the upper portion of the hand-held electronic device 1, it is determined not to conform to the initiative determination condition. The above configuration is based on the condition that when the user regularly holds the hand-held electronic device 1 and utilizes his finger to perform touch operation on the touch-sensing cover 11, the palm of the user may form a trigger zone of area contact on the lower portion of the hand-held electronic device 1, and the trigger zone of area contact is not formed on the upper portion. As to the touch region formed on the upper portion by the touch-sensing cover 11 and the finger performing the touch operation, its diameter or the longest distance from one touch edge to the other touch edge is usually not longer than 7 mm. When there is a trigger zone 113g like FIG. 7B on the upper portion of the hand-held electronic device 1 and the longest distance from its one touch edge to the other touch edge is longer than 7 mm, it is possible that the user does not perform touch operation but for example wipes the cover 111 or merely holds the hand-held electronic device 1. Therefore, if the trigger morphology of the trigger event indicates single area contact and it is located at the upper portion of the hand-held electronic device 1, it is determined not to conform to the initiative determination condition. To distinguish between the upper portion and the lower portion can depend on the center of the cover 111 or the center of the touch-sensing structure 112, and it still depends on actual situation when the user operates the hand-held electronic device 1. The portion upper than the central line is regarded as the upper portion, and the portion lower than the central line is regarded as the lower portion.

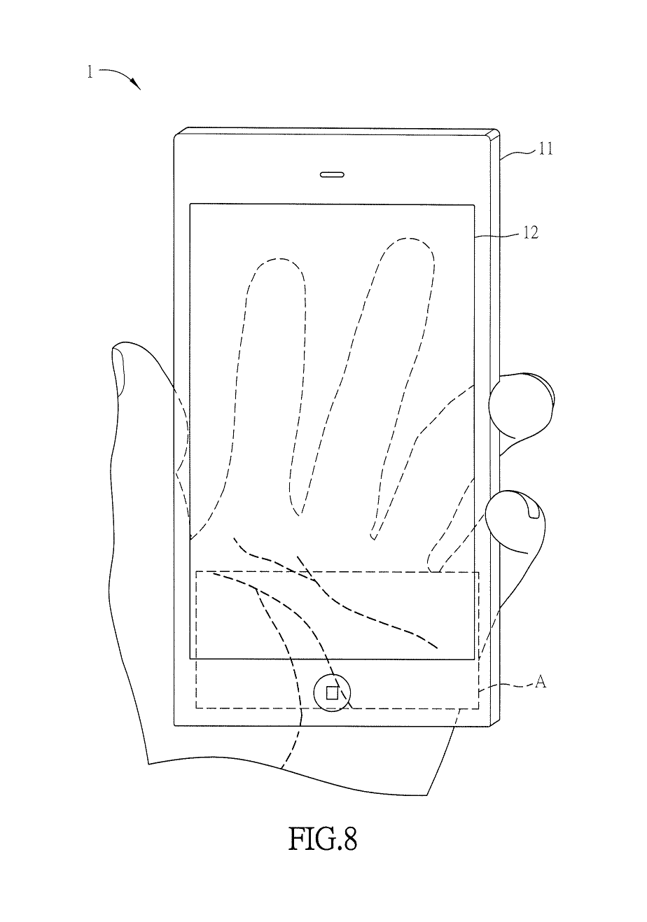

Moreover, the hand-held electronic device 1 provides a double-unlock method for enhancing security and safety. Referring to FIG. 2 and FIG. 8, FIG. 8 is a schematic diagram showing another operation state of the hand-held electronic device of FIG. 1 In the embodiment, the hand-held electronic device 1 further comprises a palmprint recognition unit 15. The location of the palmprint recognition unit 15, for example but not limited to, can be disposed in the area A in FIG. 8 for matching to the position where the palm contacts the touch-sensing cover 11. The palmprint recognition unit 15 is electrically connected to the control unit 13 and recognizes at least one part of the palmprint of the user. In practice, the user can pre-store the palmprint patterns in the storage unit 14 as the predefined palmprint patterns, and in the unlocked state, the user can set the control unit 13 of the hand-held electronic device 1 as “the double-unlock mode”. In the double-unlock mode, the user can put the palm to contact the area A of the cover 111 of the touch-sensing cover 11 when the user wants to unlock the hand-held electronic device 1. The control unit 13 can compare the palmprint in the designate area with the pre-stored palmprint pattern. If the trigger event conforms to the initiative determination condition and the palmprint corresponds to the predefined palmprint pattern, the hand-held electronic device 1 is converted into the unlocked state and the user is permitted to execute next operations. If the trigger event does not conform to the initiative determination condition, the control unit 13 determines that the user is not a permitted user, so that the hand-held electronic device 1 cannot be converted into the unlocked state. The above operation can be, for example, opening a web page, reading an e-mail, executing an application program, which is not limited thereto.

Because the unlocking method provided by the embodiment is executed on the touch-sensing cover 11 of the hand-held electronic device 1, the user's finger will neither shade the view or the software object displayed on the panel, nor the touch for opening the link in the high information density image will be erroneously executed. Since the user can execute the touch operation on the touch-sensing cover 11, the user just needs to hold the hand-held electronic device 1 by one hand to easily execute the unlocking operation through the biometric recognition while the panel 12 won't be shaded. In comparison with the conventional art where the user just can use the thumb to execute the operation while using the same hand holding the device, this disclosure can provide more efficiency and convenience for the manual operation.

As mentioned above, as to the shadeless touch hand-held electronic device and unlocking method thereof according in this invention, the user can execute the touch operation on the touch-sensing cover of the shadeless touch hand-held electronic device, so a user's fingers will neither shade the view or the software object displayed on the panel, nor the touch for opening the link in the high information density image will be erroneously executed. Since the user operates the electronic device via the touch-sensing cover, the panel scratch problem can also be reduced. Moreover, because the user can execute the touch operation on the touch-sensing cover, the user can easily execute the unlocking operation through the biometric recognition and the panel won't be shaded by using one hand holding the hand-held electronic device. In comparison with the conventional art where the user just can limitedly use the thumb to execute the operation while using the same hand holding the device, this invention can provide more efficiency and convenience for the manual operation and a wonderful user experience can be achieved.

Besides, the trigger quantity, the trigger quantity distribution, the trigger morphology, the trigger time, the trigger frequency or the trigger location must firstly conform to the initiative determination condition, then the hand-held electronic device permits the touch-sensing cover to receive at least one input operation by the user and correspondingly perform an operation such as scrolling the screen in one dimension on the panel. Therefore, when other user uses the hand-held electronic device, because the trigger quantity, the trigger quantity distribution, the trigger morphology, the trigger time, the trigger frequency or the trigger location is distinct from the initiative determination condition which is predefined by the origin user, the hand-held electronic device is forbidden to operate so as to enhance the security of the hand-held electronic device.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An unlocking method for a shadeless touch hand-held electronic device having a panel, a touch-sensing cover and a control unit, the unlocking method comprising:
detecting a user's contact of the touch-sensing cover when the hand-held electronic device is in a locked state of user interface;
computing a trigger event of a plurality of detection points on the touch-sensing cover;
comparing the trigger event with an initiative determination condition pre-stored in the hand-held electronic device; and
converting the hand-held electronic device into an unlocked state of user interface if the trigger event conforms to the initiative determination condition.

2. The unlocking method of claim 1, wherein the trigger event comprises a trigger quantity, a trigger quantity distribution, a trigger morphology, a trigger time, a trigger location or a trigger frequency.

3. The unlocking method of claim 2, wherein if the trigger morphology indicates multiple area contacts, it is determined not to conform to the initiative determination condition.

4. The unlocking method of claim 2, wherein if the trigger morphology of the trigger event indicates a single area contact and the position of the single area contact is located at the upper portion of the hand-held electronic device, it is determined not to conform to the initiative determination condition.

5. The unlocking method of claim 4, wherein the area contact means that the diameter of a single touch region on the touch-sensing cover whereby the user contacts or the longest distance from one touch edge to the other touch edge is longer than 7 mm.

6. The unlocking method of claim 1, further comprising:
receiving a palmprint by a palmprint recognition unit of the hand-held electronic device;
comparing the palmprint with a predefined palmprint pattern pre-stored in the hand-held electronic device; and
converting the hand-held electronic device into the unlocked state of user interface if the trigger event conforms to the initiative determination condition and the palmprint corresponds to the predefined palmprint pattern.

7. The unlocking method of claim 1, wherein the hand-held electronic device is used by one hand.

8. A shadeless touch hand-held electronic device, comprising:
a panel;
a touch-sensing cover, having a cover and a touch-sensing structure, wherein partial or total area of the touch-sensing structure is disposed on the cover, and the touch-sensing structure has a plurality of detection points; and
a control unit, electrically connected to the panel and the touch-sensing cover, and executing steps comprising:
detecting a user's contact of the touch-sensing cover when the hand-held electronic device is in a locked state of user interface;
computing a trigger event of the detection points on the touch-sensing cover;
comparing the trigger event with an initiative determination condition pre-stored in the hand-held electronic device; and
converting the hand-held electronic device into an unlocked state of user interface if the trigger event conforms to the initiative determination condition.

9. The hand-held electronic device of claim 8, wherein the trigger event comprises a trigger quantity, a trigger quantity distribution, a trigger morphology, a trigger time, a trigger location or a trigger frequency.

10. The hand-held electronic device of claim 8, wherein if the trigger morphology indicates multiple area contacts, it is determined not to conform to the initiative determination condition.

11. The hand-held electronic device of claim 8, wherein if the trigger morphology of the trigger event indicates a single area contact and the position of the single area contact is located at the upper portion of the hand-held electronic device, it is determined not to conform to the initiative determination condition.

12. The hand-held electronic device of claim 11, wherein the area contact means that the diameter of a single touch region on the touch-sensing cover whereby the user contacts or the longest distance from one touch edge to the other touch edge is longer than 7 mm.

13. The hand-held electronic device of claim 8, further comprising:
a palmprint recognition unit, electrically connected to the control unit.

14. The hand-held electronic device of claim 8, wherein the hand-held electronic device is used by one hand.

15. The hand-held electronic device of claim 8, further comprising a circuit board, a battery or a memory card between the touch-sensing cover and the panel.

16. The hand-held electronic device of claim 8, wherein a wiring connecting to the touch-sensing structure is gathered to a single side for wiring outlet.

17. The hand-held electronic device of claim 8, wherein the width of the touch-sensing structure is less than the width of the cover by 5% to 10%.

18. The hand-held electronic device of claim 8, wherein the area of the touch-sensing structure and the area of the panel have a ratio relationship, and the control unit converts an input position of the touch-sensing structure into a display position on the panel.

19. The hand-held electronic device of claim 8, wherein the touch-sensing structure comprises metal mesh, metal nanowires, transparent conducting film, carbon nanotube or graphene.

20. The hand-held electronic device of claim 8, wherein the touch-sensing cover further comprises a near field communication unit having a near field communication chip and an antenna, the near field communication chip is electrically connected to the control unit, and the antenna is disposed on the cover or the touch-sensing structure.
